(19) United States
(12) Patent Application Publication
(10) Pub. No.: US 2015/0019964 A1
(43) Pub. Date: Jan. 15, 2015

(54) NON-DISRUPTIVE INTERACTIVE INTERFACE DURING STREAMING

(71) Applicant: Mainstream Media Unplugged Limited, Toronto (CA)

(72) Inventor: Courtney Campbell, Toronto (CA)

(21) Appl. No.: 13/937,625

(22) Filed: Jul. 9, 2013

(51) Int. Cl. G06F 3/0484

(52) U.S. Cl. CPC G06F 3/0484
USPC 715/716

(57) ABSTRACT

The present invention relates to a non-disruptive interactive interface accessible over the streaming of content on a computer, and more specifically to a service in which at the request of a Client computer, a host server sends back a code to create a divider that is generated by the Client's browser, which opens on the Client's media player an interactive interface capable of receiving input and exchanging information over the streaming in progress. The present invention further relates to a community network connecting a Client with a unified host system in which a host provides viewers with content and social networking, and provides content providers (including advertisers and sponsors) with a mode of distributing, advertising and sponsoring content as well as using social networking for analytics results. The unified host system may be accessed by viewers and content providers through the interactive interface.

### FIELD

The present invention relates to a non-disruptive interactive interface accessible over the streaming of content (for example, motion picture) on a computer, and more specifically to a service in which at the request of a Client computer, a host server sends back a code to create a divider that is generated by the Client's browser, which opens on the Client's media player an interactive interface capable of receiving input and exchanging information over the streaming in progress.

The present invention further relates to a community network between a unified host system and Clients who view or provide content, in particular the unified host system provides social networking with content (for example, motion picture), and provides content providers (including advertisers and sponsors) with a mode of distributing, advertising and sponsoring content as well as using social networking for analytics results. The unified host system may be accessed by viewers and content providers through a non-disruptive interactive interface accessible over the streaming of content on a computer.

The present invention further relates to a unified host system comprising three unified websites via a home server, a social network server, and a content streaming server.

The present invention further relates to a community network in which a unified host system enables viewers to view streamed content while interacting on an interface on a Client media player; advertisers to provide advertisements through the interface; content providers to distribute their content and obtain sponsorship or advertisers; advertisers to provide commercials through either the interface and/or the streamed content; and viewers, content providers and advertisers to access a social network through the interface. Further, the content may be an online film festival with optional voting.

### BACKGROUND

As computers become more powerful, the television schedule may eventually be replaced by a system in which viewers are able to watch digitally stored and distributed programs or segments of programs whenever they want, on their computer, and without pre-selecting certain shows for storage.

Streaming media is multimedia that is constantly received by and presented to an end-user while being delivered by a provider. A client media player can begin playing data (such as a movie) before the entire file has been transmitted. The term “streaming media” can apply to media other than video and audio such as live closed captioning, stock ticker, and real-time text, which are also known as “streaming text”.

Live streaming, delivering live over the Internet, involves a camera for the media, an encoder to digitize the content, a media publisher, and a content delivery network to distribute and deliver the content.

Today, a media stream can be streamed either live or “on-demand”, meaning when it is requested. Live streams are generally provided by a means called “true streaming”. True streaming sends the information straight to the computer or device without saving the file to a hard disk. On-demand streaming is provided by a means called progressive streaming or progressive download. Progressive streaming saves the file to a hard disk and then is played from that location. On-demand streams are often saved to hard disks and servers for extended amounts of time; while the live streams are only available at one time only (e.g., during the hockey game).

Designing a network protocol to support streaming media raises many problems, such as:

Datagram protocols, such as the User Datagram Protocol (UDP), send the media stream as a series of small packets. This is simple and efficient; however, there is no mechanism within the protocol to guarantee delivery. It is up to the receiving application to detect loss or corruption and recover data using error correction techniques. If data is lost, the stream may suffer a dropout.

The Real-time Streaming Protocol (RTSP), Real-time Transport Protocol (RTP) and the Real-time Transport Control Protocol (RTCP) were specifically designed to stream media over networks. RTSP runs over a variety of transport protocols, while the latter two are built on top of UDP.

Another approach that seems to incorporate both the advantages of using a standard web protocol and the ability to be used for streaming even live content is adaptive bitrate streaming HTTP adaptive bitrate streaming is based on HTTP progressive download, but contrary to the previous approach, here the files are very small, so that they can be compared to the streaming of packets, much like the case of using RTSP and RTP.

Reliable protocols, such as the Transmission Control Protocol (TCP), guarantee correct delivery of each bit in the media stream. However, they accomplish this with a system of timeouts and retries, which makes them more complex to implement.

Unicast protocols send a separate copy of the media stream from the server to each recipient. Unicast is the norm for most Internet connections, but does not scale well when many users want to view the same television program concurrently,

Multicasting broadcasts the same copy of the multimedia over the entire network to a group of clients, but there are issues with this as well.

Multicast protocols were developed to reduce the server/network loads resulting from duplicate data streams that occur when many recipients receive unicast content streams independently. IP Multicast provides a means to send a single media stream to a group of recipients on a computer network. A multicast protocol, usually Internet Group Management Protocol, is used to manage delivery of multicast streams to the groups of recipients on a LAN (“Local Area Network”).

Most high-volume streaming publishers and OVPs use content delivery networks (CDNs). Like OVPs, there are multiple CDNs, large and small.

While content is streaming on a computer, in order to view other sites or media, or perform other tasks, the viewer has to minimize the ‘box’ displaying the streaming content, in order to have access to further functions available on the computer. It would be advantageous to have the ability to view other media, visit other sites and perform other tasks while content is streaming. Although television can be connected to the internet, the model and method still has not changed because the user interface is only one directional; however, the present invention is interactive. Furthermore the present invention enables responses to streaming content and the resulting interaction or lack thereof is quantifiable and provides valuable analytics.

As a stark contrast to television; although television can be connected to the internet, the model and method still has not changed because the user interface is only one directional, the user can't enter input or respond to given prompts, question or engage in dialogue.

### SUMMARY

The invention may include a non-disruptive interactive interface system. The system preferably comprises a client computer connected to the Internet and a displayer, When a user streams content from the Internet such as video or audio, an interactive interface is created and displayed on the displayer while the streaming of the content continues. The interactive interface can be used to receive user inputs, submit user inputs to other computers or servers on the Internet, and display information related to the streamed content received from (the streaming server or other computers on) the Internet. Again, the actions of the interactive interface do not interfere with the streaming of the content.

In an embodiment of the non-disruptive interactive interface system, the way the interactive interface is displayed relative to the streamed content is determined by a code received from the Internet, such as the streaming server or other servers. For example, the content display area (a window or browser) streaming the content may be divided into two areas—one for the interactive interface, the other for the streamed content, with the interactive interface overlaying a part of the streamed content. In addition, the interactive interface may be hidden if the user has not done anything for a pre-determined period of time. The hidden interactive interface is active and shown again if a user input is received, such as the mouse hovering over the area where the interactive interface should be.

In another embodiment, the user may upload content through the interactive interface. The content may be an advertisement or a film. When uploading a content, the user may associate the content to another content(s), such as designating the to-be-uploaded ads to be displayed only when motion pictures are streamed. In addition, the user may also designate how the uploaded content is displayed, such as shown in a part of the interactive area or at the beginning of an associated film.

In an alternative embodiment, the interactive interface may have multiple functions, such as being used to show advertisements, sponsorship of the streamed content, commands for controlling the streaming of the content, and a list of other recommended contents, and to prompt the user for scoring the streamed content or providing comments. At least some of these functions may be performed at the same time, and with information from difference sources. In an embodiment providing viewer voting, the embodiment may also include various fair voting detection features, such as checking the voter's IP, asking for viewer to sign in, using human detection mechanisms (e.g. Captcha), and gathering viewer interaction information during the content streaming The viewer interaction information may include how long the viewer has spent on watching the film, or whether the viewer kept pressing the forward button, etc.

In yet another alternative embodiment, a mobile device can be used as a remote control interacting with the interactive interface.

The invention may also include a unified host system for distributing multimedia content and exchanging information with a client computer. A preferred embodiment of the unified host system comprises: a home server as a portal for a client to access all services provided by the system, a content streaming server with a content database for storing uploaded content and streaming stored content and a social network server for exchanging information with the client computer.

The invention may additionally include a community network system for distributing contents and exchanging information. A preferred embodiment of the community network system comprises a client computer, a displayer, at least one server, and a content database. When a user uses the client computer to retrieve multimedia content from the server and display the content on the displayer, the client computer may initialize the displayer by requesting a code from the server and dividing the content display area (a window or a browser) streaming the content into two areas—an area for the interactive interface and the other for the streamed content. The interactive interface may partially overlay the streamed content. During the process of creating the interactive interface, the streaming of the content continues. The interactive interface can be used to receive user inputs, submit user inputs to other computers or servers on the Internet, and display information related to the streamed content received from the Internet. Whatever is done through the interactive interface does not interfere with the streaming of the content.

In an embodiment of the community network system includes three servers: a home server as a portal for a client to access all services provided by the system, a content streaming server with a content database for storing uploaded content and streaming stored content; and a social network server for exchanging information with the client computer.

In another embodiment, the interactive interface may be hidden if the user has not done anything for a pre-determined period of time. The hidden interactive interface is active and shown again if a user input is received, such as the mouse hovering over the area where the interactive interface should be.

In another embodiment, the user may upload her content through the interactive interface. The content may be an advertisement or a film. When uploading a content, the user may associate the content to another content(s), such as designating the to-be-uploaded ads to be shown only when motion pictures are streamed. The uploaded content may be reviewed for the purpose of pending payment or checking the appropriateness of the content or its association. The user may inquire about the status of the review or the analytic of her uploaded content, such as scores or votes. Then upon approval, the uploaded content will be saved to the content database and available for watching or airing. In addition, the user may also designate how the uploaded content is displayed, such as shown in a part of the interactive area or at the beginning of the associated film.

In an alternative embodiment, the interactive interface may be used to show advertisements, sponsorship of the streamed content, commands for controlling the streaming of the content, or a list of other recommended contents, or to prompt the user for scoring the streamed content. In an embodiment providing viewer voting, the embodiment may also include various fair voting detection features, such as checking the voter's IP, asking for viewer to sign in, using human detection mechanisms (e.g. Captcha), and gathering viewer interaction information during the content streaming. The viewer interaction information may include how long the viewer has spent on watching the film, or whether the viewer kept pressing the forward button, etc.

In yet another alternative embodiment, a mobile device can be used as a remote control interacting with the interactive interface.

It is an object of this invention to provide a client computer with an interface for viewers to interact with at least one server when watching a multimedia content, and the interaction does not interfere or disrupt the streaming of the content.

It is an object of this invention to provide a system for serving the needs of film viewers, providers, and sponsors. Viewers' needs may include watching, scoring, and commenting on multimedia content. Film providers' needs may include uploading their own contents, associating their contents with other related contents, designating how the uploaded contents are displayed, and seeking sponsorship. The needs of sponsors may include looking for contents that they want to sponsor, contacting the film providers of those contents, and seeing their names shown when the sponsored contents are displayed.

### BRIEF DESCRIPTION OF THE FIGURES

FIG. 1 is a schematic depiction of an interface overlaying streaming media on a client media player in an embodiment of the interface of the invention.

FIG. 2 is a schematic depiction of a client computer with a client media player having an interface overlaying streaming media, connecting with a unified host system, in an embodiment of the community network of the invention.

FIG. 3 is a pseudocode program of an interface overlaying streaming media.

FIG. 4 is an expanded schematic depiction of a client computer with a client media player having an interface overlaying streaming media, connecting with a unified host system, in an embodiment of the community network of the invention

### DETAILED DESCRIPTION

The present invention relates to a non-disruptive interactive interface accessible over the streaming of content (for example, motion picture) on a computer, and more specifically to a service in which at the request of a Client computer, a host server sends back a code to create a divider that is generated by the Client's browser, which opens on the Client's media player an interactive interface capable of receiving input and exchanging information over the streaming in progress.

The present invention further relates to a community network between a unified host system and Clients who view or provide content, in particular the unified host system provides social networking with content (for example, motion picture), and provides content providers (including advertisers and sponsors) with a mode of distributing, advertising and sponsoring content as well as using social networking for analytics results. The unified host system may be accessed by viewers and content providers through a non-disruptive interactive interface accessible over the streaming of content on a computer or internet television.

The present invention further relates to a unified host system comprising three unified websites via a home server, a social network server, and a content streaming server.

The present invention further relates to a community network in which a unified host system enables viewers to view streamed content while interacting on an interface on a Client media player; advertisers to provide advertisements through the interface; content providers to distribute their content and obtain sponsorship or advertisers; advertisers to provide commercials through either the interface and/or the streamed content; and viewers, content providers and advertisers to access a social network through the interface. Further, the content may be an online film festival with optional voting.

The unified host system provides content streaming server, a social network server and a home server in order to deliver content and also connect the viewers and providers of content. The home server allows the Client (a viewer or content provider or sponsor/advertiser) to access content or their social network or a corporate section through which content (including advertising) is provided for distribution and for advertisers/sponsors to match with content.

For example for an entertainment community, the content streaming server can deliver any media desired by viewers, including organizing media by interest categories for ease of viewer selection, the social network server can allow viewers of the content to comment on or evaluate the media and connect viewers of similar content. The social networking aspect of the site also allows content providers ready access to a fan base, giving the ability to showcase the actors and industry involved in the process and thus creating a platform for notoriety or “star building.” The corporate section can provide a forum for content providers to distribute content, and others to advertise or sponsor during content delivery. In an embodiment of the present invention, the content streaming site could provide a film festival whereby content is a selection of film entries; the content streaming site could allow voting on the films during its presentation, and interaction between social network site viewers is available during same, and the corporate entertainment section could allow content providers to submit content available on demand, and advertisers or sponsors can select from the submitted content, which selected content is available for viewing in the film festival and on demand, and further to allow voting and collection of information on viewers response to the content.

The community network of the present invention is accessible through the interactive interface although it will be understood that it can also be accessible through other portals which do not have the added complexity of accessibility over streaming of content.

### Interface

The present invention relates to a non-disruptive interactive interface accessible over the streaming of content on a computer, and more specifically to a service in which at the request of a Client computer, a host server sends back a code to create a divider that is generated by the Client's browser, which opens on the Client's media player an interactive interface capable of receiving input and exchanging information over the streaming in progress.

The interface of the present invention is accessible over streaming content. The interface is described herein in relation to a specific embodiment which has entertainment and social aspects; however it will be understood that such an interface could be described in relation to any system to allow interaction over streaming media, which media may relate to other businesses or educational purposes.

The following example of an interface of the present invention relates to an entertainment platform, and is an easily accessible unified user-friendly control center preferably with a multi-purpose graphical user interface (“GUI”). This interface enables communication privately or publicly, with friends, family or various groups, directly or simultaneously with advertisers or industry via social network, instant messaging, VOIP, email, live feed posting, QR code, pseudo-broadcasting and DIY Broadcasting etc. at the same time as streaming content. The content being streamed can be of any type capable of being transmitted online such as, multimedia, motion picture, advertisement, video, television programme, etc.

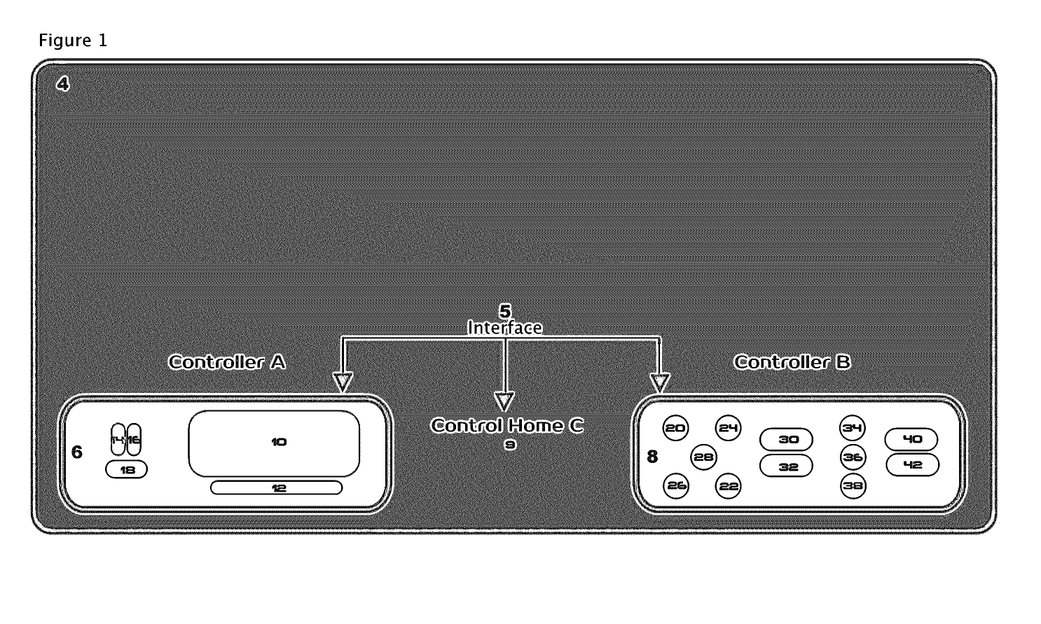

In an embodiment of the present invention shown in FIG. 1, the interface 5 is divided into three components; however, the interface of the present invention may be one or more components, and may include any variety of the interactive activities described below. FIG. 1 shows a client media player 4, such as a computer monitor or TV screen, and shows an interface 5 divided into controller “A” 6, controller “B” 8 and controller home “C” 9.

In this embodiment, controller “A” comprises an interactive screen 10, which allows input from a Client, as well as displaying various content such as commercial content, promos, incentives, QR codes, and motion picture. All the content displayed on this screen 10 can be played in unison with any movie or commercial displayed on client media player 4, and can be used to generate live comments and insert real time text or motion picture content. The reference to a “Client” means computer hardware or software that accesses a service of a server, in this case via a network to a server on a host's computer system.

Clickable icons, which are called “buttons” herein, on the interface 5 provide access to the interactive actions. For example, a film festival button 12 may be used to highlight a special feature of the interface, namely a film festival offering. For example, clicking on button 12 can activate an additional screen showing motion picture or advertising content. In an embodiment of the present invention, a film festival button 12 could bring up information about a film festival with festival details, promotions and fanfare, all seen over the motion picture showing on client media player 4.

Further buttons can be provided with simple commands such as a positive response of ‘Yes’ on button 14 and a negative response of ‘No’ on button 16 to questions that may appear on the interactive screen 10. In order to input an affirmative or more complex response, an “enter” button 18 can be provided.

Controller “B”, in an embodiment of the present invention, has a variety of available commands, such as, channel changing with a channel up button 20 and channel down button 22, and volume changing with a volume up button 24 and volume down button 26.

In an embodiment of the present invention, an additional special feature of the interface 5 is a connection to a social network. In this embodiment there is a clickable social network button 28 that allows the Client to select and use instant messaging, email, VOIP, etc. or go directly to their personal social network page set up to be coordinated with the system of the present invention. Additionally members of the social network can post comments on a film while it is running on client media player 4. Such social network or networks can be set up by the host and/or by third parties and made available through the interface.

In an embodiment of the present invention, an additional special feature of the interface 5 is the availability to participate in voting on whatever is being viewed on client media player 4. For example, in an embodiment of the invention in which there is a film festival, the viewer can participate in a vote process by selecting vote button 30. The voting system can be set up in a variety of ways, for example a viewer could be allowed to assign a value to the film such that the scores for each film in a film festival are tabulated to find a winner, and further voting could be made available only up to fifteen minutes after viewing a film. Again, a member of the social network set up by the host could post comments on the film being voted on for viewing by other members of the social network. In this manner, social networks could be created which gather likeminded individuals, for example, film buffs, or specific genres of film fans.

In an embodiment of the present invention, a clickable guide button 32 allows the Client to call up an electronic programming guide to view and engage the selection of scheduled media content available on the streaming server channels.

In a further embodiment of the present invention, a clickable screen size button 34 allows the Client to engage their browser and change the screen to a bigger size, for example quarter or half or maximum dimension, without leaving the session. Further, the appearance of controller “A” 6 and controller “B” 8 can be customized to have different appearances, for example, to appear as if made of glass (see through), metal, or acrylic, which is chosen using settings button 36. The settings button can include other settings, for example, a lock or unlock setting whereby in lock position the controller “B” 8 can be set to lock into place over the motion picture playing on client media player 4 or unlock whereby the controller will hover up only when prompted.

Additional elements can be included on controller “B” 8, such as a mute button 38 that allows the Client to mute the volume; a clickable web options button 40 that allows the Client to call up a digital option menu providing information, for example, on trivia, subscription, sponsors, channels, film festival selections; and a clickable on demand button 42 that allows the Client to view a library of films. This function when enabled will simulate the live streaming experience of the other channels.

The interface 5 is available while the Client is viewing content on the client media player 4 which means that the interface 5 can be used to allow advertising to appear on the interface 5 at the same time as the Client is viewing content, and as such there are no direct commercial interruptions to the content. The streaming content can be presented with commercials, without commercials, or with commercials only before and after a discrete show or movie, and likewise commercial content can be delivered, or not, through the interface 5. The interface 5 can be used as the primary mode of delivering interactive commercials or sponsor messages etc. in order not to interrupt the streaming content.

The interface 5 may additionally comprise further components such as displaying one or more standalone logos to represent controller home 9 which when clicked on allow the Client to go directly to the host home page or a sponsor's website or an advertiser's e-store etc. As such, controller home 9 can have the appearance of the host, sponsor or advertiser's trademarks.

As will be understood, the appearance of the interface 5 can be shown in one or multiple separate components, and additionally the appearance of the buttons or logos can be shown with user friendly symbols or words or combination to enable the user to instinctively understand the nature of the button's functions or what the logo will link to, for example, the word VOTE for voting or the symbol of a screen expanding for changing the screen size. In the above description the term “button” is used to evoke the feeling of the buttons that were on a remote control; however in reality these buttons are actually clickable icons which when clicked, cause certain functions to transpire.

In action, the Client's first contact with the Host will be to arrive at a landing page through the home server 48 which gives the viewer the option of selecting a desired channel or content on the streaming site through the streaming server 50 or direct destination such as a social network page through the social network server 52, or corporate pages through streaming file server “A” 54 to Censor page, or direct to Sales page 58 or Sponsorship availability page 35 or Stats page 67. After a selection of content is made the interface 5 becomes active and streaming image begins to appear behind the interface and occupy the full client media player screen.

When the client media player is streaming media, the interface 5 can be set to fade away/hover down and can be represented as a persistent identification logo seen over the full screen live streaming content. Hovering over the logo or toward the bottom of the client media player screen (if there is no visible identification logo) will bring back the interface.

Once the interface 5 is pulled up on the client media player 4, many options and controls are available to the Client (end user) as set out above (change streaming channels, mute, volume, guide, vote, on demand and web options buttons). Connections to the host website hornepage and direct links to other sections of the main website such as a social networking- blogging section can be made from the interface using the options button. The interface can be set up to appear in the most simplistic form whereby clicking on buttons will engage action or hovering the cursor over sections of the interface can access pull down menus.

The interface 5 can give the viewer access to film marquee, film competition voting stats, program information and profiles which can exist as pop ups over live streaming content.

The On Demand interface can differ from the interface for live streaming in that playback functions specific to On Demand viewing can be used such as play/pause, location bar, fast forward, rewind, next and previous chapter, image size, guide, vote, web options. Clicking on buttons to engage actions or hovering over the buttons can again bring up pull down menus. The On Demand interface can have a timed hide default feature as well.

While the interactive interface can be used to merely provide and exchange between a viewer and a content provider, it can also be used as part of a community network between viewer, content provider and industry.

### Community Network

The present invention relates to a community network between a unified host system and Clients who view or provide content, in particular the unified host system provides social networking with content (for example, motion picture), and provides content providers (including advertisers and sponsors) with a mode of distributing, advertising and sponsoring content as well as using social networking for analytics results.

The unified host system may be accessed by viewers and content providers through a non-disruptive interactive interface accessible over the streaming of content on a computer.

Thus the present invention further relates to a community network in which a unified host system enables viewers to view streamed content while interacting on an interface on a Client media player; advertisers to provide advertisements through the interface; content providers to distribute their content and obtain sponsorship or advertisers; advertisers to provide commercials through either the interface and/or the streamed content; and viewers, content providers and advertisers to access a social network through the interface. Further, the content may be an online film festival with optional voting.

The community network may be utilized as described herein for a community in the field of entertainment and consist of viewers and content providers, however, the community could also comprise viewers who are also content providers. The community network of the present invention can also be adapted to any field. For example, in an educational context, the content could be educational videos provided by a school board, the viewers could be students and the advertisers or sponsors could be providers of school materials or a municipality. For example, in a scientific context, the content could be scientific lectures provided by scientists, the viewers could be other scientists and the advertisers or sponsors could be a university or a drug company, and voting could be included to determine which lectures receive “peer review” type status.

Further, the community network can comprise a public community (even if membership is required initially to join) or a private community (e.g. a school and its members, or a company and its employees) or a combination of both with some server pages only accessible by members/employees.

### Delivery

An embodiment of the present invention relates to a service in which at the request of a Client computer, a Host server sends back a code to create an interactive interface, capable of receiving input and exchanging information on a client media player, which interface is generated by the end user's browser over the streaming in progress on the client media player.

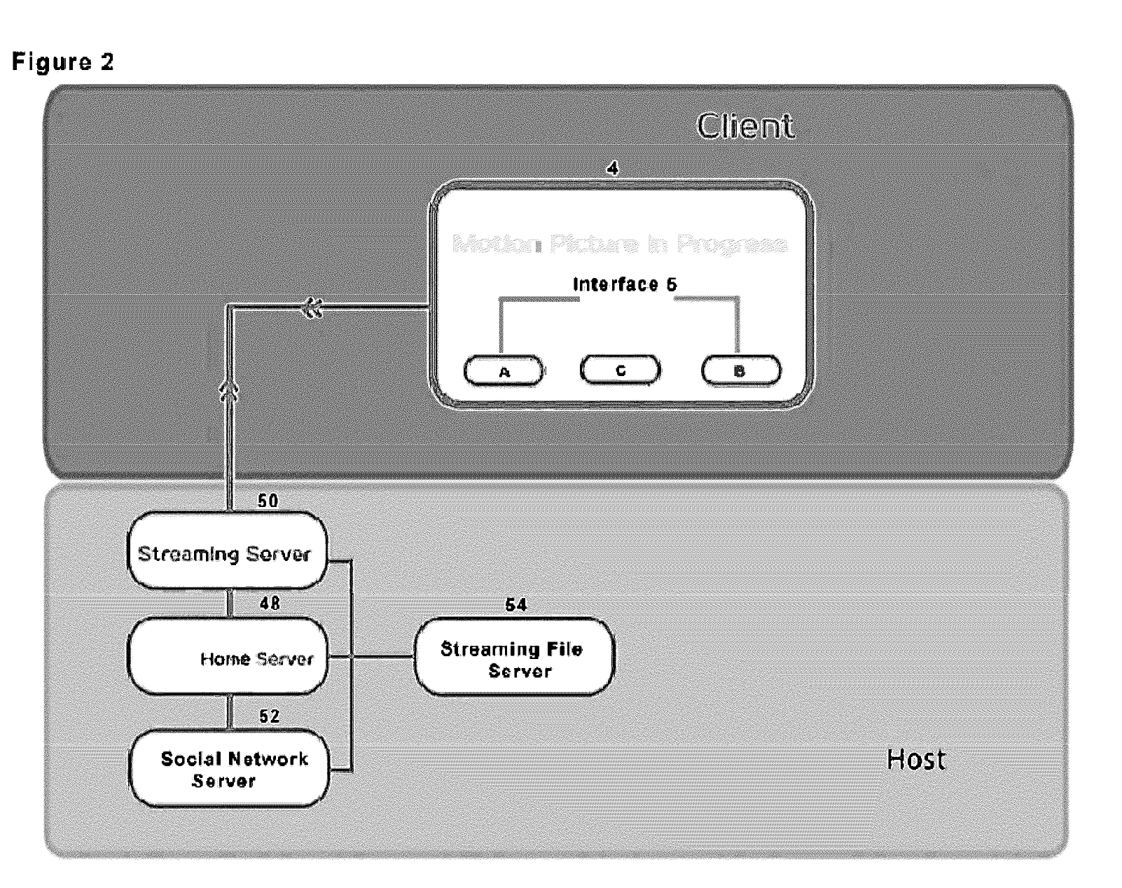

FIG. 2 is a conceptual diagram to show an embodiment of the present invention in which at the request of a Client Computer 44, a Host computer system 46 consisting of three unified websites (streaming, home and social network) directs the Client computer 4 to the Host home server 48 which is the landing page providing access to the content through the streaming server 50 or social network through the social network server 52 or to services for content providers, such as sales 58. The Client seeking content can select one of the channel icons on the landing page that directs them to and opens the Host Streaming Server 50 and connects them to that stream. Once there, the viewer can change channels, get information and have a variety of options for customizing their experience as discussed above with respect to the interface 5 and the various options available through the interface 5 divided in this example between controller “A” 6, controller “B” 8 and controller home “C” 9. The home server 48 will also provide search capability for content.

A content provider, sponsor or advertiser would have a different interest than a viewer, and could choose to access the corporate pages. For viewers and corporate users, the host's homepage can serve as the main hub for all end user functions, sales queries, contacts, links and controls but many of the website's pages can be accessed directly from the interface such as On Demand, programming guide, or social network.

In an embodiment of the present invention Real-time Streaming Protocol (RTSP) is used to stream content, including motion pictures.

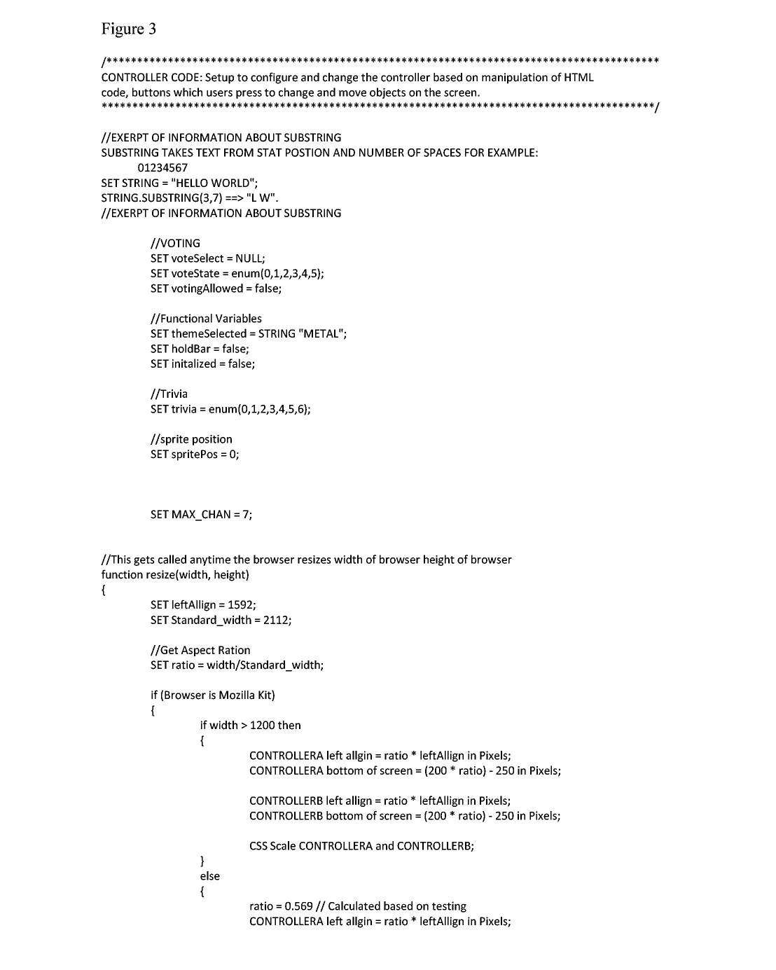

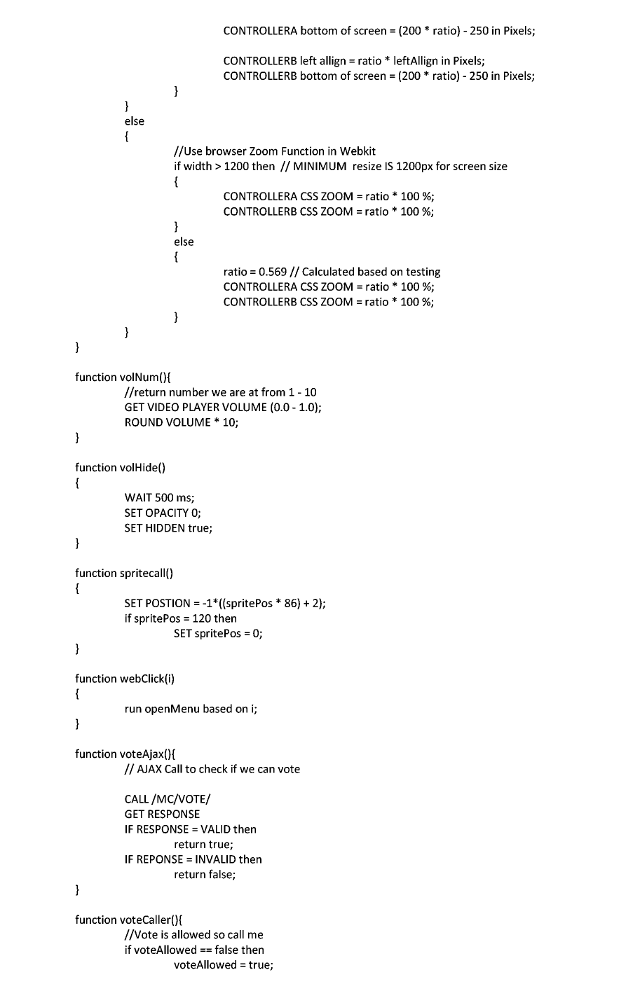

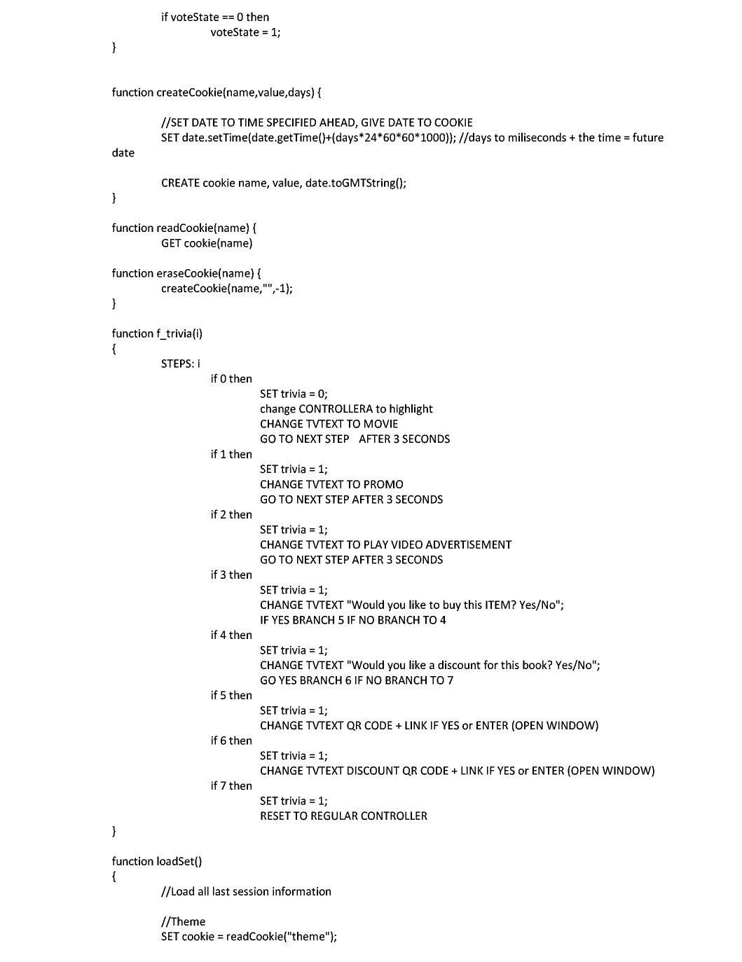

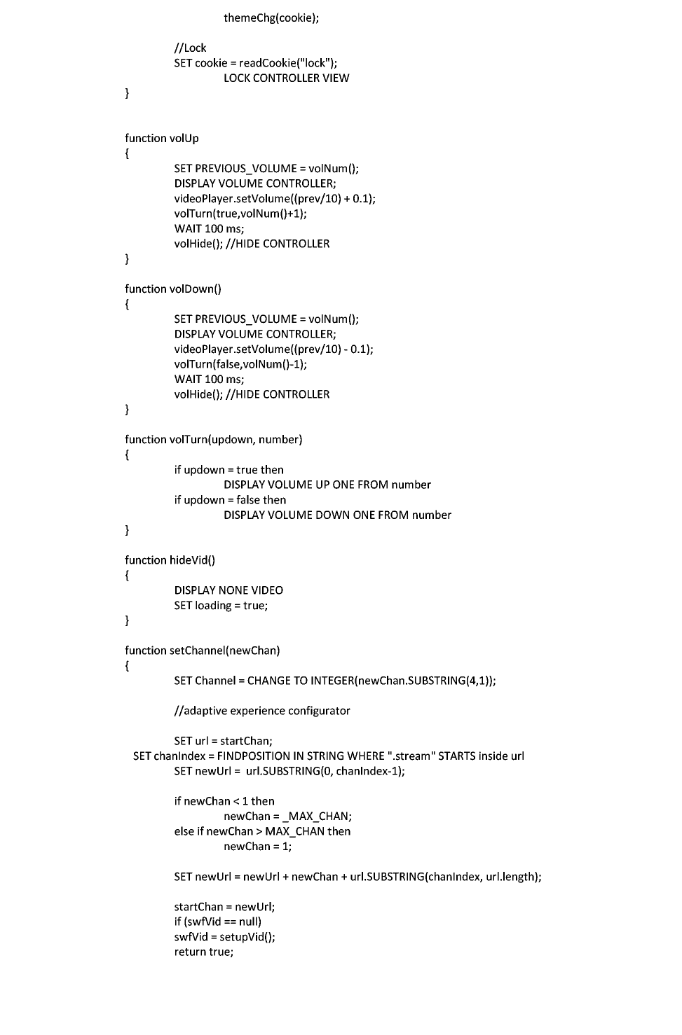

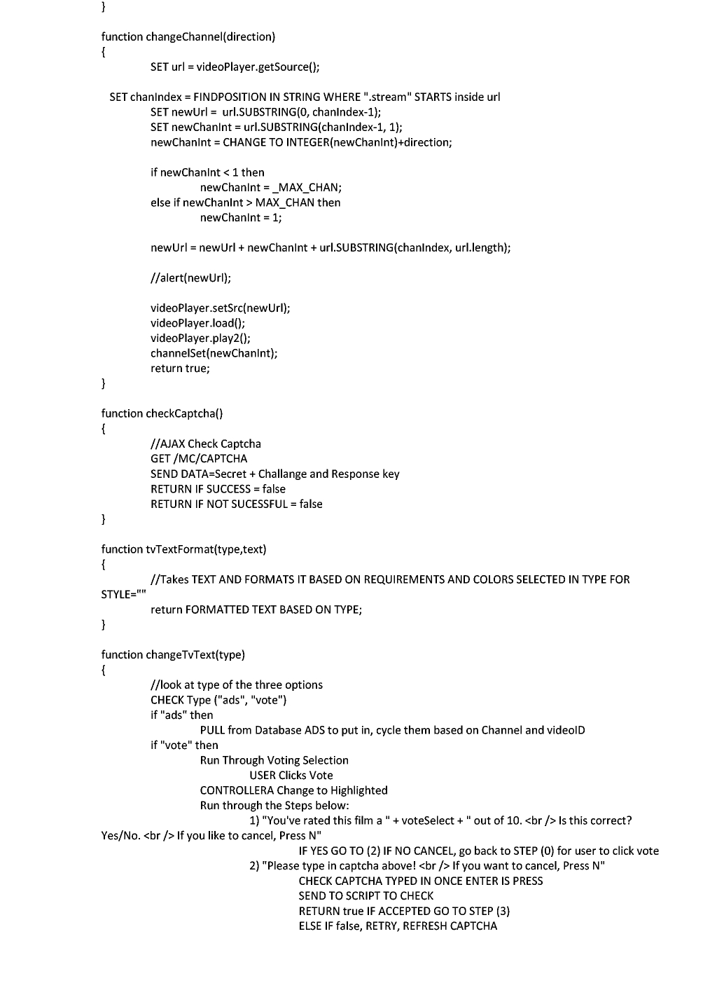

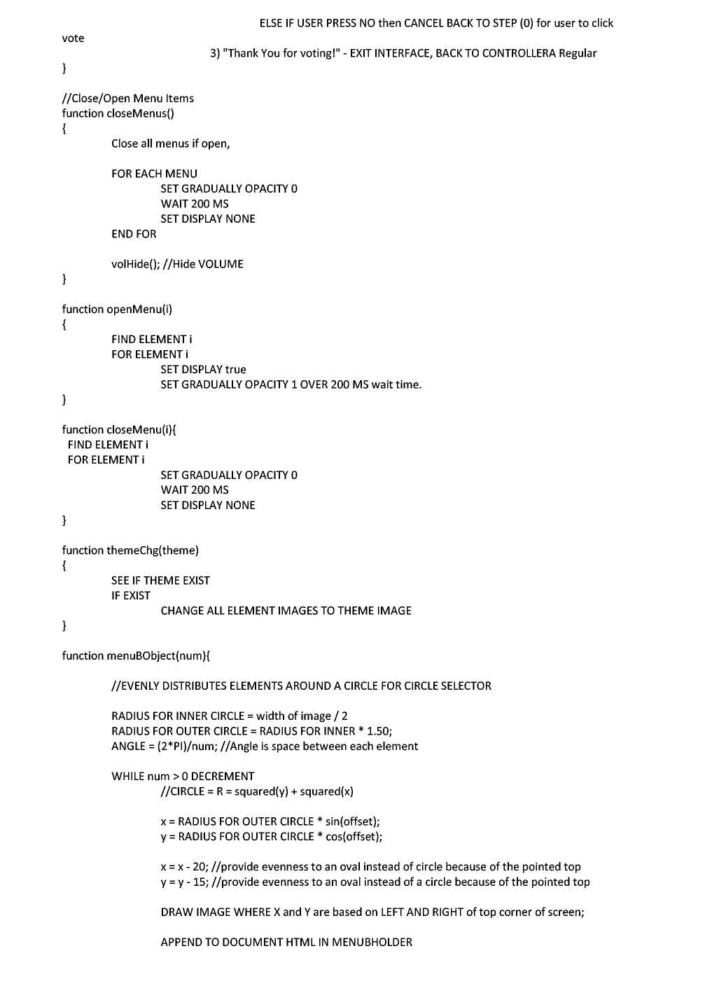

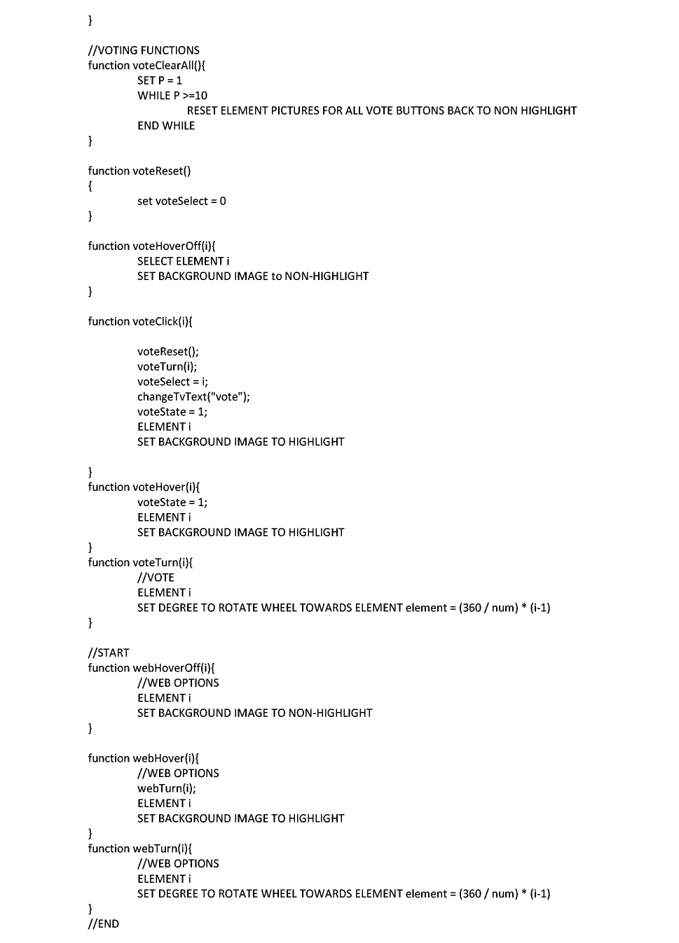

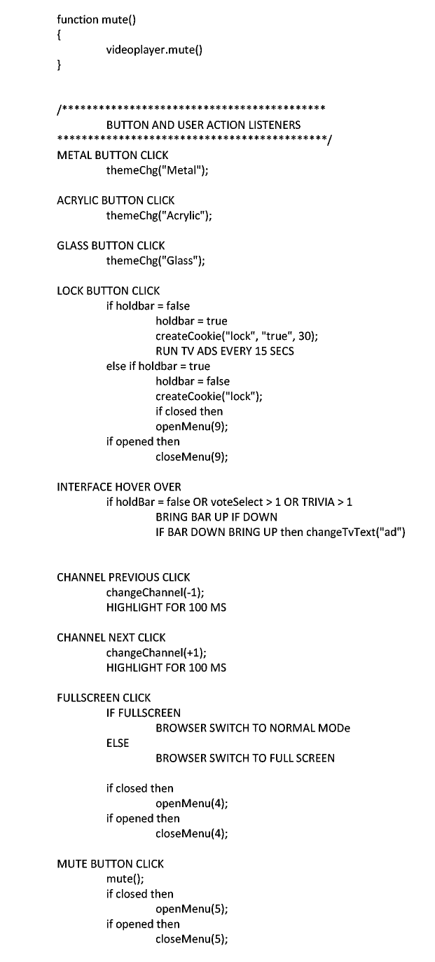

As will be understood, the programming to enable the interface 5 to appear over streaming in progress may be written in a variety of different computer languages. In pseudocode, the programming for an embodiment of the present invention of an interactive interface is provided in FIG. 3.

Connectivity is a problematic issue in delivering to large audiences. Bandwidth plays a pivotal role in delivering higher quality content. For example A 10 GigE internet connection will be required to service approximately 4500 viewers simultaneously. This is a hurdle when trying to service traffic of 45000 to 100,000 viewers at any one time. Availability to this type of connection is very expensive and difficult to acquire. In order to meet the demand of delivery the present invention is designed with redundancies and also with virtual hosting replicas in multiple locations which will also be of assistance when providing local advertising and time zone change issues.

### Content Provider

A Client with content, for example a film, that wants to submit to the Host, creates an account via a registration option on the host website. The Client uploads content, for example a film, after filling out required data and meeting all video format specifications. The film is uploaded to a file server to be reviewed by the host and if approved, the Client is notified and the host slots the date and time if within a film festival or traditional programming.

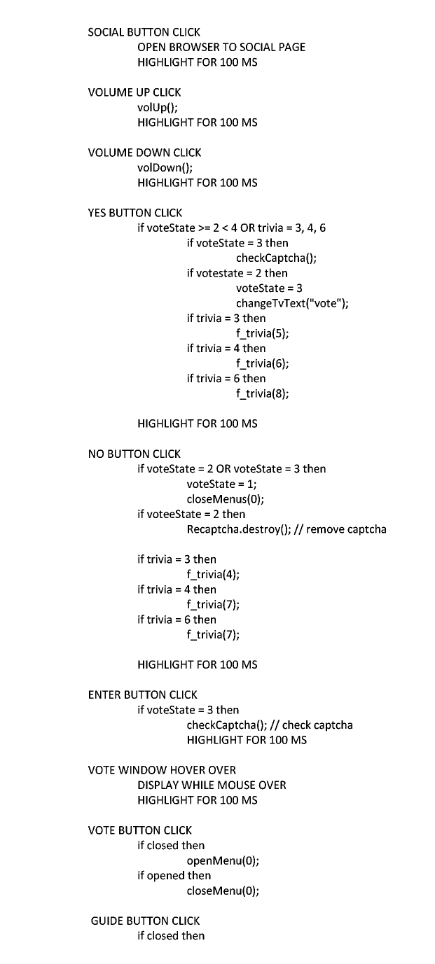

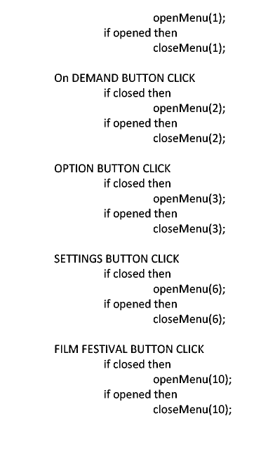

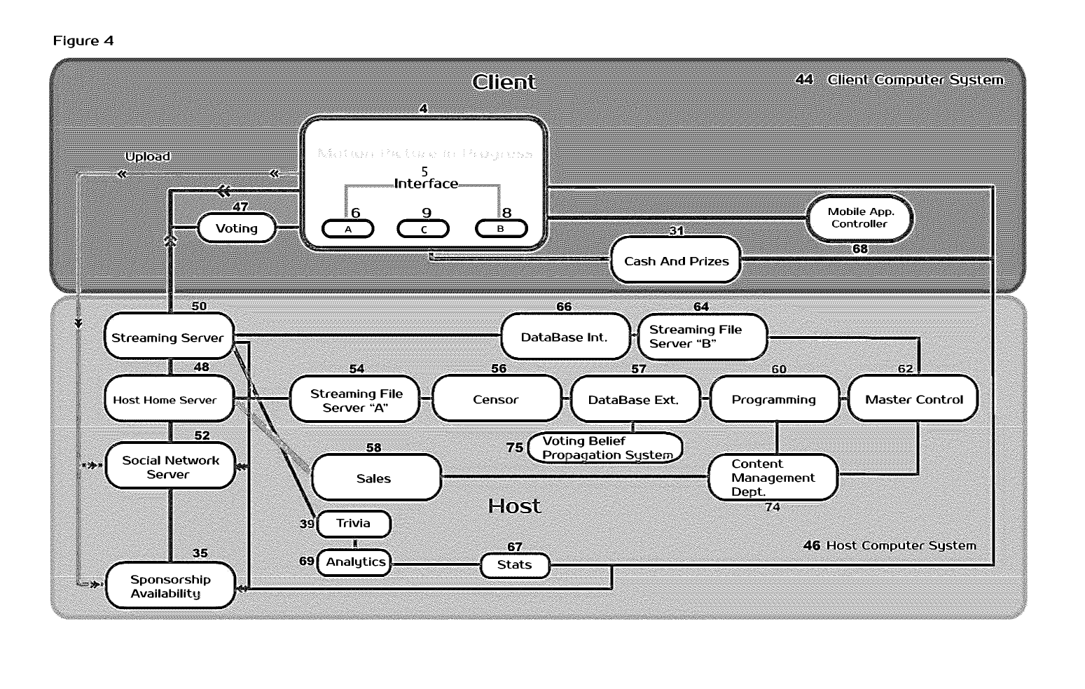

FIG. 4 expands on FIG. 2 from the point of view of the Host's participation. In this embodiment of the present invention, the Host computer system 46 comprises the streaming file server “A” 54 through which the content provider accessed and delivers the content. After which the host pages of a censor 56, an external database 57, programming department 60, master control 62 are in place to process such content. Once the host accepts and processes the content, it is loaded onto a streaming file server 64 and stored on internal database 66 all of which comprise the supports that supplies and connects the back end to the unified web sites contained on the streaming server 50, home server 48 and the Social Net Server 52, and together they form the Host system that facilitates the Client request and experience.

In more detail, a film is uploaded to a file server “A” 54 to be reviewed by the Censor department 56. An alert is sent to the film maker that file has been received and is under review. The Censor 56 reviews and approves/rejects film. The censor also notes any logical errors with video or sound. The content management department 74 tracks film's review status for all departments. Film is retrieved from external database 57 by programming department 60 from file server “A” 54 and is edited/fixed and reviewed if necessary.

Film is marked for scheduling and final review for Master Control 62. Master Control 62 confirms scheduling and film status, alert is sent to film maker that film has been slotted with date and time. Film is uploaded into internal database 66 and available to be shown via streaming channels and On Demand.

The Client can track the basic resulting analytics 69 from the statistics tab 67 accessed through their social network page. Trivia 39 can also be accessed through analytics page 69.

Furthermore, if a film does not have sponsorship, the host can pair the film with sponsorship, otherwise the Client can submit commercial media, such as commercials, to be synchronized within the film and or seen on the interface 5 during the film. The Client can also submit other content to be shown through the interface 5 at the same time, for example a film's page with details on the film linked from their web page.

Alternatively, if a film does not have sponsorship, the Client can access the sponsorship availability page 35 through which a content provider and advertiser or sponsor can match and negotiate the pricing through which content will be linked with advertising/sponsorship. The unified host system provides content and social networking for viewers and provides content providers with distribution and social networking; however, in a further embodiment of the present invention it also provides content providers with an opportunity to obtain advertising or sponsorship to enable the content to be included in the internal database. A content provider (film maker or producer) can post a request for advertising and/or sponsorship and this request is viewable by the Host and corporate members that are interested in providing advertising and sponsorship. The advertiser or sponsor responds by way of a private bidding system accessible from their social networking pages to the content provider and the parties can negotiate a deal.

### Film Festival

The content that can be provided and viewed using the community network is also capable of being organized by the host into an online film festival. Content, namely films, will be provided in the same way as described above. The excitement of a film festival when online can generate further exchange of information between content providers and viewers both through the interface, the streaming media and the viewer and content provider social network pages. Additionally, viewers can vote on the films.

An online film festival has the advantage of unlimited viewers and excitement created through live streaming. Optionally and additionally an online film festival provides access to films at the convenience of the viewer through the on demand feature. As with other theatre based film festivals, the content providers are given an opportunity to have their film seen and potentially sponsored or given further distribution. An advantage for advertisers and sponsors is the unique ways in which they can present their own content through the interface.

### Voting

In the example in which a film festival is being run, the interface 5 allows the viewer to vote, but when content is viewed outside of a festival or contest, the vote button can be disabled on the interface 5. The vote button 30 when clicked can display further options, for example, a number selection wheel can appear so the viewer can grade the film, and further, prompts can be included such as ensuring that selection is correct, in which case the “Yes” button 14 or “No” button 16 can be clicked. As well, and to ensure fair voting, a belief propagation system 75 may be included to detect the viewers' interaction during the delivery of same. This belief propagation system 75 can form a part of the vote scoring tabulation process; used to deliver the most accurate voting possible. And a Captcha can appear to complete the vote confirmation, eliminating the possibility of robotic or script voting. As well prompts can get the viewer to provide their email address for notification of results and/or join a social network.

Voting can be included in an interactive interface with respect to other community networks, for example, voting by peers of content such as lectures, or nonprofessional videos.

The following is an example of a vote propagation belief system of the present invention:
1) The controller reports to server every 30 seconds.
2) The controller receives feedback from the server, obtaining if the controller can enable voting, looking at ip of user, login if any, and video ID of specific channel
3) The vote button is enabled after a time frame set by length of movie minus 15 minutes.
4) The vote process starts when user presses the vote button, asking for selection of 1-10.
5) The vote process is verified, in this example by using captcha, to ensure user is an actual person entering a vote.
6) The captcha, vote, channel and a secret value is sent to server for verification
7) The information is verified and placed into database upon success if not a false is returned and captcha will need to be re-entered with a different captcha.
8) The vote is entered for the user logged in or by ip, and once entered the person cannot vote for that video ID again.

The ranks are arranged using a ratio comprised of the # of votes, 4 of short views, # of complete views and the mean vote score.

View Function determines short view and a complete view
1) Upon entering a watch page video, info is sent to controller, which will enable a timer.
2) The video which is being viewed; if viewed for 15 minutes, the controller will verify with server and add that as a short view.
3) If the person viewed the entire movie, from start to finish, this will be entered as a complete view
4) If a partial view is recorded the viewer may resume watching the entire video at a later time and be marked as a complete view if logged.

### Advertising

In a further embodiment of the present invention as shown in FIG. 4, an additional option is for the Client to post their advertisement through the interface 5. The Host's sales department could be contacted by phone or alternatively through the home server 46, which will then engage a connection to those alternative ways of contacting sales by email, messaging or VOIP. The Client computer 44 connects to the Host via streaming server 50, home server 46 or social net server 48 and to sales 58 and then connects back to Client. Once directed to sales 58, a representative can provide optional analytics and campaign options. After establishing which campaign to pursue the Client can use a self-serve check out for payment; finalize order details, confirm ad slots or space rental for web and or streaming via a content management system. The Client then gains access to upload their ad for review.

The Client can either choose to DIY (Do It Yourself) allowing them the submission of commercial media content destined for the continuous programming available on streaming server channels shown on client media player 4, placement in the on demand section of the unified host system website as activated by on demand button 42 or to be placed on the interactive screen 10 on controller “A” 6.

Alternatively the Client can elect to get support from the Host sales team or submit their own campaign rather than using the DIY methods. All submitted static ads, streaming video ads and embedded video ads go through a censor process and the advertising is quality control checked and placed appropriately.

Advertisers can advertise through the interface or directly on the main screen with various types of ads such as, text ads, display ads, pop-up ads, HTML5 animation or other motion graphics, interstitial ads, embedded video ads etc. Sponsors of a particular film can also pair with the filmmaker's accreditation list (e.g. stars, crew, producers etc) that have joined the social networks and place/link additional advertising on these pages.

Advertisements go through the review process (censor 56, programming 60, Master Control 62), just as content would. Advertisers can also optionally use the trivia 39 generated by the host to provide cash, promotional offers, giveaways and prizes 31 that can be instantly emailed to the winners and confirmed in moments along with other reciprocal incentives.

The social network of the present invention may also be utilized by content providers, advertisers and sponsors as a way to provide information about their content or advertised products/services but also as a way to retrieve statistics, such as, analytics 69 and trivia 39, relating to their content. Statistics 67 on content and ads may relate to how many views, comments, length of time viewed etc.

### Feedback

The present invention enables viewer responses to streaming content and the resulting interaction or lack thereof is quantifiable and provides valuable analytics. The present invention enables monitoring of instant reactions of the viewer of content, including the type of entertainment selected, and relays this information to the advertiser or sponsor or content provider in real time. The viewer can reciprocate in real time to prompts, trivia and promotions, and they can write and deliver instant messages, e-mails and video testimonials as the viewing is in progress. In an embodiment of the present invention, content, e.g. film, is provided to a viewer (either with or without commercials) and real time feedback is provided to the film distributor and/or filmmaker and if any, to the advertiser.

### Mobile Application

As technology develops the present invention can be modified as well, but it is understood that the interface of the present invention can be used on mobile devices through a mobile app controller 68 as shown in FIG. 4. For the mobile app all the functions related to site interaction are conducted on a hand held mobile device.

### Remote Mobile Application

The Remote Mobile Application allows a user to download an application to a hand held mobile device that will allow a user to use a touch screen as a remote controller to the website; allowing a user to conduct many functions remotely, such as, volume, channel changing etc. while the remote app interacts with a secondary device i.e. client computer.
1) The controller during the 30 seconds call to server will call remote functions
2) The controller pulls to see if anything should be clicked.
3) If something should be clicked the controller will run that function as If the user clicked the button.

The remote in hand will take inputs for the specific user logged in and put it in the database. The server references the database for that user who must be logged in to use the remote.

From the above detailed descriptions, the operation and construction of same should be apparent. While there are herein shown and described example embodiments of the invention, it is nevertheless understood that various changes may be made with respect thereto without departing from the principle and scope of the invention.

We claim:

1. A non-disruptive interactive interface system, comprising:
1) a client computer communicably coupled to an Internet;
2) a displayer communicably coupled to the client computer; and
a non-transitory computer-readable storage medium communicably coupled to the client computer and storing computer-executable instructions configured to:
(a) display a first display area on the displayer an interactive interface and a second display area on the displayer a content streamed from the Internet; and
(b) receive a user input via the interactive interface,
sending the user input to the Internet, and
display an information relevant to the content being streamed from the Internet without disrupting streaming and displaying of the content to the second display area.

2. The non-disruptive interactive interface system of claim 1, wherein the computer-executable instructions are further configured to:
1) request a code from the Internet; and
2) display the first display area and the second display area according to the code, the first display area partially overlaying the second display area.

3. The non-disruptive interactive interface system of claim 2, wherein the computer-executable instructions are further configured to:
1) hide the first display area when a predefined hide time is up; and
2) show the hidden first display area when a cursor hovers over the first display area.

4. The non-disruptive interactive interface system of claim 1, wherein the user input is a command for controlling the streaming and displaying of the content.

5. The non-disruptive interactive interface system of claim 1, wherein the user input comprises a second content.

6. The non-disruptive interactive interface system of claim 5, wherein the user input further comprises an association between the second content and the group consisting of the content, a third content, and combinations thereof

7. The non-disruptive interactive interface system of claim 5, wherein the user input further comprises a display destination of the second content.

8. The non-disruptive interactive interface system of claim 1, wherein the information received from the Internet and displayed on the interactive interface further comprises the group consisting of an advertisement, a sponsorship of the streamed content, a command menu, a list of media in the content database, and combinations thereof

9. The non-disruptive interactive interface system of claim 1, wherein
1) the information received from the Internet further comprises a voting request;
2) the user input further comprises a voting input; and
3) the computer-executable instructions are further configured to show a voting interface within the interactive interface when receiving the voting request.

10. The non-disruptive interactive interface system of claim 1 further comprises a mobile device communicably coupled to the client computer, wherein the computer-executable instructions are further configured to receive the user input from the mobile device.

11. A unified host system for distributing a content and exchanging an information with a client computer, comprising:
1) a home server;
2) a content streaming server coupled to the home server and a content database; and
3) a social network server coupled to the home server, wherein
(a) the home server receives a user input and according to the user input, assigns a connection with the client computer to the group consisting of the home server, the content streaming server, the social network server, and combinations thereof;
(b) the content streaming server provides streaming of the content; and
(c) the social network server exchanges the information with the client computer.

12. A community network system for distributing a content and exchanging an information, comprising:
1) a client computer;
2) a displayer coupled to the client computer;
3) at least one server coupled to the client computer;
4) a content database coupled to the at least one server; and
5) a non-transitory computer-readable storage medium coupled to the client computer and storing computer-executable instructions configured for the client computer to:
(a) displaying a content display area on the displayer;
(b) requesting a code from the at least one server;
(c) dividing the content display area into at least a first display area and a second display area according to the code, the first display area partially overlaying the second display area;
(d) displaying the second display area the content streamed from the server and the first display area an interactive interface; and
(e) receiving the user input from the user via the interactive interface, sending the user input to the server, exchanging the information with the server, and displaying the information received from the server without disrupting streaming of the content to the second display area.

13. The community network system of claim 12, wherein the at least one server further comprises:
1) a home server coupled to the content database;
2) a content streaming server coupled to the home server and the content database;
3) a social network server coupled to the home server, wherein
a. the home server receives a user input and according to the user input, assigns a connection with the client computer to the group consisting of the home server, the content streaming server, the social network server, and combinations thereof
b. the content streaming server provides streaming of the content; and
c. the social network server exchanges the information with the client computer.

14. The community network system of claim 12, wherein the computer-executable instructions are further configured to:
1) hide the first display area when a predefined hide time is up; and
2) show the hidden first display area when a cursor hovers over the first display area.

15. The community network system of claim 12, wherein the user input is a command for controlling streaming of the content.

16. The community network system of claim 12, wherein the user input further comprises a second content.

17. The community network system of claim 16, wherein the second content is uploaded to the content database after the second content is approved.

18. The community network system of claim 17, wherein the at least one server provides a review status and an analytic result of the second content.

19. The community network system of claim 16, wherein the user input further comprises a display destination of the second content.

20. The community network system of claim 12, wherein the information displayed on the interactive interface further comprises the group consisting of an advertisement, a sponsorship of the streamed content, a command menu, a list of media in the content database, and combinations thereof.

21. The community network system of claim 12, wherein
1) the information further comprises a voting request;
2) the user input further comprises a voting input; and
3) the computer-executable instructions are further configured to show a voting interface within the interactive interface.

22. The community network system of claim 12 further comprises a mobile device coupled to the client computer, wherein the computer-executable instructions are further configured to receive the user input from the mobile device.
